(19) United States
(12) Patent Application Publication
(10) Pub. No.: US 2008/0013640 A1
(43) Pub. Date: Jan. 17, 2008

(54) Multi-dimensional burst link access streaming transmission (BLAST) architecture and algorithms for low latency real-time broadband burst data/video transmission

(75) Inventors: Cheng Lu, Rego Park, NY (US); Richard Locarni, Stony Brook, NY (US); Richard Hummel, E. Patchogue, NY (US); Frank Haunstein, Wading River, NY (US); Michael Dombrowski, Wantagh, NY (US)

Correspondence Address: VOLPE AND KOENIG, P.C., UNITED PLAZA, SUITE 1600, 30 SOUTH 17TH STREET, PHILADELPHIA, PA, 19103, US

(73) Assignee: Data Device Corporation, Bohemia, NY (US)

(21) Appl. No.: 11/700,359

(22) Filed: Jan. 31, 2007

Related U.S. Application Data
(60) Provisional application No. 60/772,667, filed on Feb. 13, 2006.

(51) Int. Cl. H04L 23/02

(52) U.S. Cl. 375/261; 375/260

(57) ABSTRACT

A multi-dimensional Burst Link Access Streaming Transmission (BLAST) architecture, which provides flexible physical apparatus for balanced performance of data throughput, latency, and reliability of transmission (e.g. graceful degradation). A schedule is sent from a master node to alert targeted nodes regarding messages to be sent. The master node uses a P-Band transmission link operating a regular intervals to synchronize the system in preparation for receipt of a message over a synchronous link. Each node has the capability of sending and receiving synchronous and asynchronous messages.

This application is a Non-Provisional of U.S. patent application which claims the benefit of U.S. Provisional Application No. 60/772,667 and filing date of Feb. 13, 2006, which is incorporated by reference as if fully set forth.

### FIELD OF THE INVENTION

The present invention relates generally to transmission systems and to digital transceivers for use in broadband communication systems, and more particularly, to provide Multi-Dimensional Burst Link Access Streaming Transmission (BLAST) algorithms which can, in the time and the frequency domain, dynamically adaptively adjust transmission of data over a wide transmission rate range while maintaining low network latency.

### BACKGROUND

In burst digital communications the data is typically packed into a sequence of transmission packets. Those data packets can be transmitted via various transmissions schemes. In order to have reliable high data rate transmission via various cable channel environments, two basic transmission schemes have been used: single-carrier Quadrature Amplitude Modulation (QAM) technology and multi-carrier Orthogonal Frequency Division Modulation (OFDM) technology. These technologies provide relatively high bandwidth efficiency. QAM technology is relatively less complex than OFDM technology, and has been used in many major commercial products (for example: DOCSIS based cable modems). On the other hand, with the inherent frequency shaping flexibility and relative insensitivity to channel in-band distortion, OFDM has been increasingly adopted in industrial standards, for example, the DVB-T Euro. HDTVstandard.

In some particular applications, such as military, automobile, industrial auto-control systems, the need for high data rate, and low latency, as well as graceful transmission degradation control, become equally critical. In such applications, neither QAM based architecture nor OFDM based architecture will provide satisfactory or equivalent performance.

The present invention is characterized by comprising a multi-dimensional Burst Link Access Streaming Transmission (BLAST) architecture, which provides flexible physical means for balanced performance of data throughput, latency, and reliability of transmission (e.g. graceful degradation).

### SUMMARY OF THE INVENTION

The present invention consists of two inter-related key technologies:

1. Combination of Synchronized/Asynchronized Multi-channel architecture with:

Wide-band: synchronized half-duplex transmission band (OFDM based).

Narrow-band: asynchronized half-duplex transmission band (QAM based).

Pilot band: asynchronized simplex transmission band (QAM based).

2. Three-dimensional dynamic data transmission: Data transmission from one node to the other can be done via three (3) physical means: physical channel selection (Wide-band and Narrow-band), sub-frequency channel selection (Bin-locations in Wide-band), and time-slot selection in Wide-band. Those physical means are independent variables in Network Resource Allocation (NRA) space. In the present invention, data transmission is characterized in 3D-NRA space of (physical channel, sub-frequency, time-slot). For example, based on transmission condition (SNR, BER, Network node traffic condition, etc.), a network master alters data transmission from one channel to the other, and/or alter the time-slot(s) to dynamically allocate the network resource to maintain a balanced Network transmission level in terms of network throughput, latency, and reliability of the transmission.

### BRIEF DESCRIPTION OF THE FIGURES

FIG. 1 is a block diagram of a transmission network embodying the principles of the present invention.

FIG. 2 is a diagram showing the modulation schemes which may be employed in the present invention.

FIGS. 3A and 3B are block diagrams showing one embodiment for transmitting and receiving data and control at two typical nodes in the system and FIG. 3 shows the manner of arrangement of FIGS. 3A and 3B.

### DETAILED DESCRIPTION OF THE INVENTION

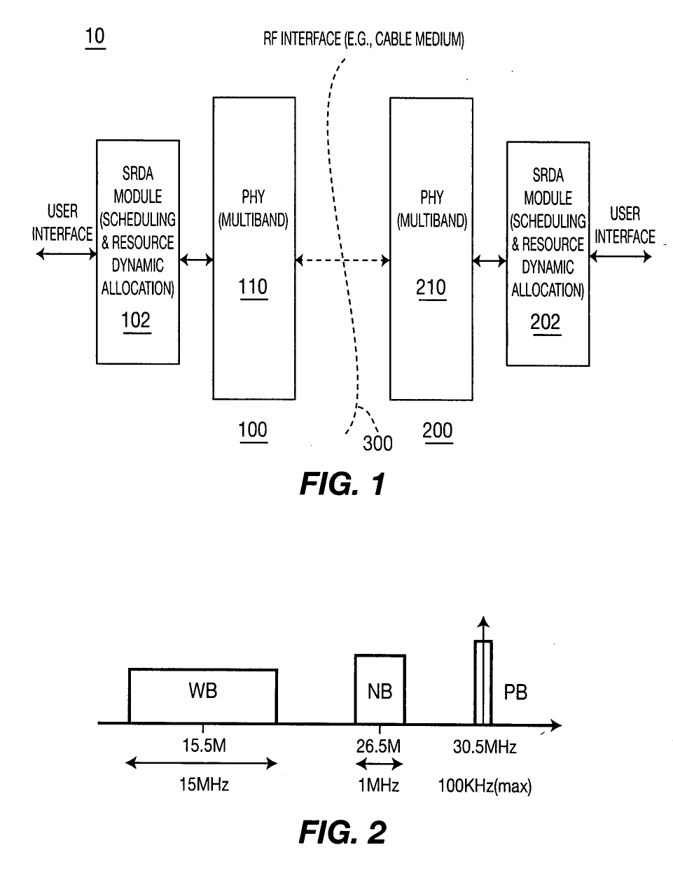

The Overview BLAST architecture 10, is shown in FIG. 1 and comprises:

Blast Architecture, which Comprises Two Layer Processing:

(1) A Scheduling and Resource Dynamic Allocation Module (SRDAM).

In this module, multi-channel utilization is provided to leverage the strength of each band and transmission technology accordingly, via the establishment of three (3) interdependent links.

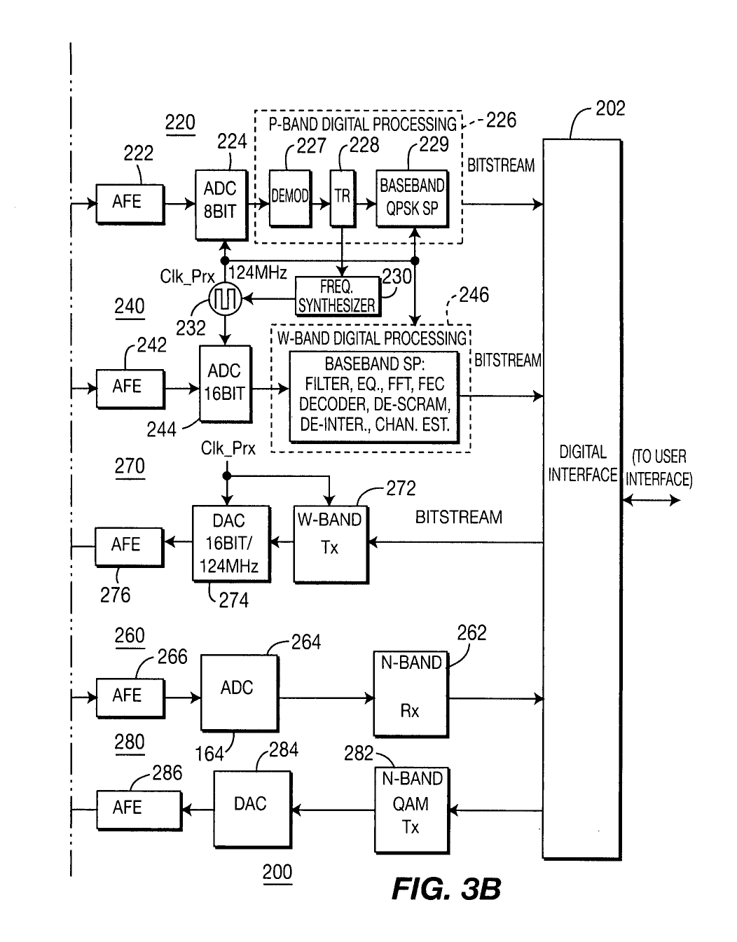

In setting up a network of devices utilizing this technology it is envisioned that one of the nodes 100 is designated as the network controller. See FIGS. 1 and 3. This node has the role of generating the scheduling for the network, which is established based upon node and network requirements (bandwidth, update rate, etc.). Determination of the network requirements can either be explicit for a closed network, or dynamic via a login phase. Once the network controller 100 establishes a schedule, it is provided to all of the nodes, such as node 200, via a broadcast over the Narrow-band link. This schedule defines time slice allotments of the Wide-band link for each node. Upon obtaining this schedule, each node locally manages its schedule and utilizes the Pilot-band for synchronization with the network clock, as will be described in detail below. Since all nodes locally maintain their own copy of the schedule, and use the same Pilot-band time base, it is possible to provide synchronized utilization of the asynchronous Wide-band link.

Dynamic network changes are accommodated via periodic reassessment of the schedule by the network controller or in response to network changes (i.e., lost or added nodes, changes in bus stability, etc.). Establishment of a new network schedule by the network controller results in an update broadcast over the Narrow-band link, initiating the use of the new schedule. The schedule is preferably sent on a regular basis, such as one-second intervals. When there are no changes in the schedule, the latest update is resent.

(2) Physical Layer (PHY) Multi-Band Module

In this module, the data to be transmitted is modulated based on defined modulation schemes (OFDM or QAM), band location (wide-band or narrow-band, or pilot band), and the transmission time slot(s). The transmission parameters are determined by the SRDAM 102 shown in FIG. 1.

The data received from the user interface (not shown for purposes of simplicity) is converted to a digital format and sent to SRDAM 102, which creates the schedule, to be described below.

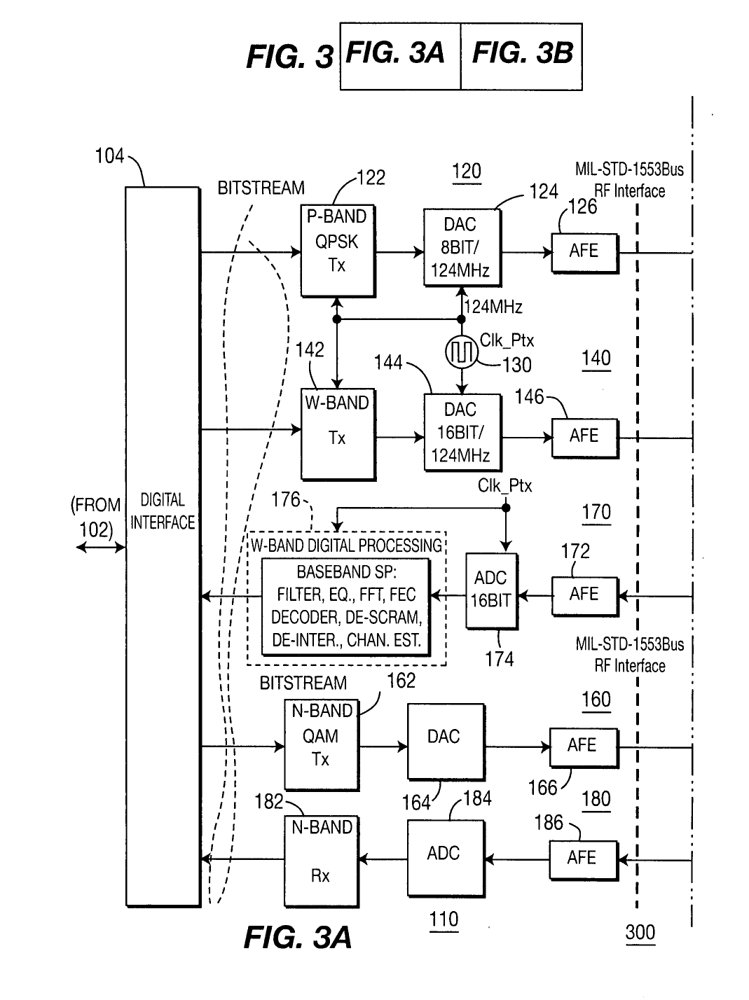

FIGS. 3A and 3B, taken together in the manner shown in FIG. 3, show a block diagram of the transmitters/receivers of the physical (PHY) links 110 of first node 100, which serves as the network controller, and the physical (PHY) transmitter/receiver links 210 of another node 200 communicating with the network controller node 100. Only two (2) nodes have been shown for purposes of simplicity, it being understood that the number of nodes may be 100 or more. Making reference to FIGS. 1 and 2, the SRDAM 102 is coupled to the transmitters and receivers of node 100 by way of digital interface 104. SRDA 102 schedules the data according to certain criteria, as will be described in detail below.

The narrow band (N-band) link 160, whose principal characteristics are shown in FIG. 2, comprises narrow band (N-Band) quadrature amplitude modulation (QAM) transmitter 162 which performs QAM on the bit stream derived from SRDAM 102. The output of transmitter 162 is applied to an 8-bit digital-to-analog converter (DAC) 164. The output of DAC 164 is coupled to an analog front end (AFE) 166 which, as is conventional, performs filtering, amplification and shaping of the signals applied to the radio frequency (RF) interface which may be any media such as a cable bus such as a MIL-STD 1553 bus, a twisted pair cable, a wireless channel, or the like.

The output of AFE 166 is sent through the radio frequency (RF) interface 300 and is received by the AFE 266 of receiving link 260 of PHY link 220, comprised of AFE 266, analog to digital converter (ADC) 264, comprising an 8-bit ADC and N-Band receiver (Rx) 262, which applies the bit stream to a digital interface 202 forming part of SRDAM 202. AFE 266 amplifies and conditions the received signals, as is conventional. The SRDAM 202 manages reception and transmission at node 200.

The digital interface 202 at node 200 is coupled to a host interface, such as a peripheral component interface (PCI), a host computer or control device (not shown for purposes of simplicity).

The host interface comprises the SRDAM 102 which identifies the time slice allotments of the wide-band (W-band) link for node 200. SRDAM 102 is coupled to the PHY links 110 by digital interface 104, and controls the wide-band (W-band) transmitter (Tx) 142, forming part of the transmission link 140 for selecting the time slot perimeters.

W-band Tx 142 employs sub frequency division multiplexing upon the bit stream derived from digital interface 104. W-band transmitter (Tx) 142 is controlled by a local clock 130 which also provides timing for the P-Band transmitter (Tx) 122, DAC 124, W-Band Tx 142 and DAC 144. The bit stream, modulated at 142 and converted into analog form by D/A converter 144, is applied to AFE 146 which conditions the modulated signals preparatory to entering the RF interface 300.

AFE 242 of receiving PHY link 240 receives the analog modulated bit stream which is applied to 16-bit analog to digital converter (ADC) 244.

The modulated digital signal undergoes W-Band digital processing at 246 which includes base-band signal processing (SP), filtering, equalization, Fast Fourier Transform (FFT), decoding by forward error correction (FEC), descrambling, de-interleaving and channel estimation, providing a bit stream, at base-band, of the output of the W-band digital processor 246, for application to digital interface 202 and then to the host interface through digital interface 202.

Synchronization of the W-band receiver link 240 at node 200 is obtained by way of the pilot-band (P-band) quadrature phase shift keying (QPSK) transmitter (Tx) 122 whose operating frequency is controlled by clock 130, as was described above. The bit stream entering P-band Tx 122, is applied to 8-bit digital to analog converter (DAC) 124, operating at the clock frequency of 124 MHz. The modulated analog signals applied through AFE 126 of PHY link 120, enter interface 300. AFE 222 of P-band link 220 applies the received, modulated signal to 8-bit analog to digital converter (ADC) 224. The output of ADC 224 is coupled to the P-Band digital processor 226 and undergoes digital processing at processor 226 for purposes of timing recovery, processor 226 comprising demodulator 227, timing recovery circuit 228 and baseband QPSK signal processor (SP) 229. The bit stream derived from processor 226 is also utilized to pass the schedule to the SRDAM forming part of digital interface 202 and thereby prepare node 200 for receipt of a high priority message, for example.

The output of timing recovery circuit 228 is applied to a local clock source 232, also operating at 124 MHz and having its timing corrected by frequency synthesizer 230, the local clock source 232 providing clock timing for ADC 224, QPSK SP 229, W-band digital processor 246 and ADC 244.

The transmission of synchronized bit streams from node 200 to node 100 is provided by link 270 whose W-band Tx 272, 16 bit digital to analog converter (DAC) 274 and AFE 276 are substantially identical in design and function to Tx 142, DAC 144 and AFE 146, described above.

The output of AFE 276 is transmitted to AFE 172 of link 174 through RF interface 300 (described above) and received by AFE 172, converted at 16-bit ADC 174 and a W-band digital processor 176 substantially identical in design and function to the AFE 242, ADC 244 and W-band digital processor 246 respectively, which comprise receiver link 240 for node 200.

Transmission from node 200 to node 100 is either from the PHY W-band link 270 or the N-band PHY link 280. As a result of the reception of the transmission from node 200 by node 100, the host may alter the schedule.

Explanation of Procedure for the Embodiment Shown in FIGS. 1-3

The transmission techniques of FIG. 2 provide the advantages of each of the PHY links relative to one another. As one example, when a burst of data delivered to SRDAM 102 has a high priority and/or requires that the burst be sent at a high level of accuracy, SRDAM 102 determines that this burst be sent by the W-band transmitter. This requires that a schedule be sent to the recipient node (node 200, for example) before the burst is sent. The schedule is preferably handled by the P-band transmitter, although the N-band transmission link 160 may be employed as an alternative.

Node 100 preferably uses the P-Band link for sending the schedule and preferably sends the schedule at regular intervals. In one embodiment, the schedule is sent at one (1) second intervals, although a greater or lesser interval may be adopted dependent, among other things, schedule length and number of nodes in the system. The P-band transmission link 120 and its clock source 130 provide synchronization for the system and all of its nodes. It should be understood that node 100 may; transmit simultaneously over its transmission links; transmit and receive simultaneously and simultaneously receive messages over the W-Band and N-Band receiver links. The other nodes in the network have like capabilities (except they are normally not equipped with a P-Band transmitter—however, one or more nodes may be designated as standby master nodes and be provided with P-Band transmission links).

The schedule prompts the targeted node(s) to prepare for receipt of high priority data. In one preferred embodiment, assuming the system comprises 100 nodes, a different time slot is assigned to each node, the time slots each being an interval of one millisecond (1 msec.). The binary state of one bit position in the time slot notifies the node of a data burst intended for that node when in one binary state (i.e., binary “1”), and no high priority data is intended for that node when that bit position is in an opposite binary state (i.e., binary “0”). Alternatively, bit positions in one common time slot may be assigned to each of the nodes.

SRDAM 102 then controls transmission of the high priority data burst via W-Band transmission link 140. The portion of the schedule intended for node 200 adjusts the clock 232 at node 200, thereby synchronizing the W-Band receiving link 240. Employing OFDM, the wide band may be divided into a large plurality of sub frequency ranges depending upon the needs of the network. As one example, the W-Band may be divided into 128 sub frequency bands and different messages may be sent over each one of the 128 sub frequency bands, each band being assigned to a given node, for example, (thus, the system may comprise 128 nodes). A greater or lesser number of sub frequency ranges may be provided according to the needs of the network.

Although the schedule may be sent by the N-Band transmission link at node 100, the P-band is nevertheless used for synchronization when high priority data is sent by the W-Band link 140.

In the event that node 200 wishes to send high priority data to node 100, SRDAM 202 controls the N-Band transmission link 280 to notify node 100. The high priority data burst is then sent over the W-Band transmission link 270. The high priority data burst, in one embodiment, is sent in time slots reserved for use by node 200.

What is claimed:

1. A communication method for sending data from a first node over a given communication channel with the objective of enhancing efficiency of transmission comprising:
providing a plurality of transmission techniques each having a given advantage over all remaining transmission techniques;
evaluating data to be transmitted;
selecting one of said techniques based on said evaluation;
sending a message identifying the technique employed for sending said data; and
transmitting said data employing the selected technique.

2. The method of claim 1, further comprising:
providing a receiving facility at a second node with a plurality of receiving techniques;
receiving the identifying message; and
selecting the receiving technique for receiving the data to be transmitted responsive to the technique identifying message.

3. The method of claim 1, said first node:
providing transmission techniques including at least QAM and OFDM.

4. The method of claim 2, said second node:
providing receiving techniques including at least QAM and OFDM.

5. The method of claim 1, one transmission technique comprising:
modulating a carrier with the data to be transmitted employing orthogonal frequency division multiplexing (OFDM).

6. The method of claim 5, further comprising:
converting the OFDM modulated carrier into an analog signal; and
sending the analog signal to an analog front end.

7. The method of claim 6, the analog front end:
filtering, amplifying and shaping the analog signal; and
sending the analog signal to the second node.

8. The method of claim 7, the second node:
receiving the OFDM signal from the sending node at a receiving analog front end.

9. The method of claim 8, comprising:
converting the OFDM signal at the receiving analog front end to digital form OFDM; and
converting the digital form OFDM signal to a digital bit stream.

10. The method of claim 9, wherein the step of converting the digital form OFDM signal to a digital bit stream comprises:
converting the digital OFDM signal to baseband.

11. The method of claim 7, the step of sending the signal to the receiving node comprising:
sending the signal over a bus.

12. The method of claim 7, the step of sending the signal to the receiving node comprising:
sending the signal over a coaxial bus.

13. The method of claim 7, the step of sending the signal to the receiving node comprising:
sending the signal over a twisted pair bus.

14. The method of claim 7, the step of sending the signal to the receiving node comprising:
sending the signal over a wireless channel.

15. The method of claim 1, one transmission technique comprising:
modulating a carrier with the data to be transmitted employing quadrature amplitude modulation (QAM).

16. The method of claim 11, further comprising:
converting the QAM modulated carrier into an analog signal; and
sending the analog signal to a second node from an analog front end.

17. The method of claim 11, the analog front end:
filtering, amplifying and shaping the analog signal and sending the analog signal to the second node.

18. The method of claim 15, the second node:
receiving the QAM signal from the sending node at a receiving analog front end.

19. The method of claim 18, comprising:
converting the analog from OFDM signal at the receiving analog front end to digital form.

20. The method of claim 19, comprising:
performing baseband signal processing on the digital OFDM signal to generate a bit stream of the data from the second node.

21. The method of claim 1, the step of sending the message identifying the technique employed for sending the data further comprising:
using a QPSK technique.

22. The method of claim 1, wherein one of the transmission techniques is a synchronous technique, said first node:
transmitting a modulated pilot for use synchronizing data sent by the synchronous technique; and
transmitting data employing said synchronous technique.

23. The method of claim 22, a receiving node:
receiving the data transmitted by the first node using a synchronous technique;
receiving the modulated pilot; and
employing the modulated pilot to synchronize the data received from the first node.

24. The method of claim 1, said analyzing step further comprising:
creating a schedule based upon given criteria; and transmitting the schedule.

25. The method of claim 24 further comprising:
transmitting the schedule at regular intervals.

26. The method of claim 24 further comprising revising the schedule responsive to changing conditions.

27. The method of claim 1, said first node further comprising:
assigning a time slot to each node served by said first node; and
alerting at least one of the served nodes of a given condition by transmitting an alerting message in the time slot assigned to said at least one of the served nodes.

28. The method of claim 1, said first node further comprising:
assigning a sub frequency to each node served by said first node; and
alerting at least one of the served nodes of a given condition by transmitting an alerting message in the sub frequency assigned to said at least one of the served nodes.

29. The method of claim 24 further comprising:
transmitting data according to the schedule.

30. The method of claim 24 further comprising:
selecting the transmission technique according to the schedule.

31. The method of claim 24 wherein the criteria includes at least one of importance level of the data latency, data throughput, reliability of transmission and degradation of at least one of network elements and transmissions.

32. Apparatus for sending data from a first node over a given communication channel with the objective of enhancing efficiency of transmission comprising:
providing a plurality of devices having different transmission techniques each technique having a given advantage over the devices of all remaining transmission techniques;
an evaluator for evaluating data to be transmitted;
a selector for selecting one of said techniques responsive to said evaluator;
a transmitter for sending a message identifying the technique employed for sending said data and transmitting said data employing the selected technique.

33. The apparatus of claim 32, further comprising:
a receiving facility at a second node having devices each configured to provide different receiving techniques, each technique corresponding to one of the techniques provided at the first node;
one of said second node devices being configured for receiving the identifying message; and
a second node selector for identifying the second node device to receive the data to be transmitted responsive to the technique identifying message.

34. The apparatus of claim 32, said first node devices being configured to provide transmission techniques including at least QAM and OFDM.

35. The apparatus of claim 33, said second node devices being configured to provide receiving techniques including at last QAM and OFDM.

36. The apparatus of claim 32, one device being configured to modulate a carrier with the data to be transmitted employing orthogonal frequency division multiplexing (OFDM).

37. The apparatus of claim 36, said one device further comprising:
a converter configured to convert the OFDM modulated carrier into an analog signal and forwarding the analog signal to an analog front end.

38. The apparatus of claim 37, the analog front end being configured to filter, amplify and shape the analog signal and
send the analog signal to the second node.

39. The apparatus of claim 38, the second node:
receiving the OFDM signal from the sending node at a receiving analog front end.

40. The apparatus of claim 39, comprising a second node:
having a device configured to convert the OFDM signal at a receiving analog front end to digital form and provide the converted signal as a stream of digital data.

41. The apparatus of claim 40, wherein the device for converting the digital form OFDM signal is configured to convert the digital OFDM signal to baseband.

42. The apparatus of claim 32, the device for sending the message identifying the technique employed for sending the data being configured to use a QPSK technique.

43. The apparatus of claim 32, said first node device being configured to transmit a modulated pilot signal for synchronizing data sent to a receiving node communicating with the first node.

44. The apparatus of claim 43, the receiving node having a device configured to employ the modulated pilot received from the first node to synchronize the data received from the first node.

45. The apparatus of claim 32 further comprising an analyzing device configured to create a schedule based upon given criteria to condition a receiving node to select a receiver for receiving data from the first node.

46. The apparatus of claim 45, the first node comprising a transmitter configured to transmit the schedule at regular intervals.

47. The apparatus of claim 45, the analyzing device being configured to update the schedule responsive to changing conditions.

48. The apparatus of claim 32, said first node further comprising:
a device configured to assign one of a time slot and a frequency band to each node served by said first node; and
alerting at least one of the served nodes of a given condition by transmitting an alerting message in the time slot or frequency band assigned to said at least one of the served nodes.

49. The apparatus of claim 32, said first node further comprising:
a device configured to assign a sub frequency to each node served by said first node; and
alerting at least one of the served nodes of a given condition by transmitting an alerting message in the sub frequency assigned to said at least one of the served nodes.
